(19) United States
(12) Patent Application Publication
(10) Pub. No.: US 2007/0234901 A1
(43) Pub. Date: Oct. 11, 2007

(54) Method and apparatus for airborne particle concentration and collection

(76) Inventors: Timothy A. Pletcher, Eastampton, NJ (US); David Keller, New Town, PA (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/255,264

(22) Filed: Oct. 21, 2005

Related U.S. Application Data
(60) Provisional application No. 60/620,701, filed on Oct. 21, 2004.
(60) Provisional application No. 60/654,781, filed on Feb. 18, 2005.

(51) Int. Cl. B03C 3/011

(52) U.S. Cl. 95/78; 96/60

(57) ABSTRACT

Embodiments of an apparatus for concentrating and collecting airborne particles (e.g., biological aerosols) from an air sample include an inlet adapted for receiving the air sample (e.g., from an external or surrounding environment), a first diffuser coupled to the inlet and adapted to concentrate the airborne particles into a particle flow, and at least a second diffuser coupled to the first diffuser in a cascaded configuration and adapted to further concentrate the particle flow.

### CROSS REFERENCE TO RELATED APPLICATIONS

This application claims the priority of U.S. Provisional Patent Application No. 60/620,701, filed Oct. 21, 2004 (entitled “Electrostatic Air-To-Air Particle Concentrator”), and of U.S. Provisional Patent Application No. 60/654,781, filed Feb. 18, 2005 (entitled “Electrostatic Gas-To-Gas Particle Concentrator And Collection”), both of which are herein incorporated by reference in their entireties.

### FIELD OF THE INVENTION

The present invention generally relates to the sampling of air, and more particularly relates to the collection of pathogen and aerosol particles from air samples.

### BACKGROUND OF THE INVENTION

Among the challenges facing the nation in the post-Cold War, post-9/11 eras, the threat of biological warfare and subsequent spread of contamination may prove to be the most insidious. Therefore, there is a need for small, inexpensive devices to collect, concentrate, detect and identify airborne biological contaminants (e.g., in buildings, enclosed facilities, and other open areas). Challenges that currently face the deployed and developing biological collection/concentration platforms are at least four-fold.

A first concern is the power consumption and achievable particle concentration of the collection technology. Existing collection and concentration technologies are based on inertial methods, which use tremendous amounts of power (e.g., several hundreds of watts). Although these technologies can produce high flow rate concentrations, they typically result in low overall particle concentration (e.g., 20-30×) due to inefficient particle collection. Other alternative technologies (e.g., acoustic and electrostatic technologies) do not have the capability to concentrate particles in the desired 50-100× range.

A second concern relates to biological single-particle triggers and the need for an output stream with a small diameter and low velocity. Existing optical trigger devices require a high particle concentration with a radially confined airflow stream of less than Ø1.5 mm to ensure single particle triggering with high specificity.

A third concern is the efficiency of methods used to capture sub-micron particles and liquid chemical aerosols. Biological threats could be packaged in sub-micron particulate aerosols and/or liquid chemical aerosols. Existing collection and concentration systems are unable to capture sub-micron particles with appropriate efficiencies (e.g., >50%) in order to be detected. Additionally, existing systems are unable to collect and concentrate liquid chemical aerosols.

A fourth concern is the ability to obtain statistically meaningful measurements in clean room environments. A class 1 clean room is defined as a space in which only a single particle exists per cubic meter. Most conventional particle size analyzers that can measure single particles have very low input air flow rates (e.g., approximately 1 lpm); consequently, it takes a very long time (e.g., approximately 1000 minutes) to find a single particle. Moreover, a large number of semiconductor lots must be processed. Thus, the sample rate is too low to justify its measurement.

Small, inexpensive devices to collect, concentrate, detect and identify airborne biological contaminants could also be useful in industry. For example, as semiconductor geometries are reduced well into the sub-micron range, the ever-present anathema of particle contamination onto the surfaces of wafers becomes more problematic. Clean room strategies are changing to meet this problem and increase circuit yields. The typical solution in the clean room has been to segment the clean area into smaller and smaller spaces such that a “clean area” within the clean room is becoming the standard approach for semiconductor processing.

As the areas and “clean” volumes are reduced, it is more economical to constantly monitor the particulate in the “clean” air such that the information can be reliably used as a process control. The air-to-air concentrator provides and important function for the measurement of the “clean air”.

The measurement problem is one of accuracy. A class 1 clean room is defined as a space where there exists a single particle per cubic meter. Most particle size analyzers that can measure single particles have very low input air flow rates. Typically the air flow rate into such an instrument is about 1 liter per minute. At this sampling rate, 1000 minutes would be required to find a single particle and many semiconductor lots would have been processed. Thus, the sample rate is too low to justify its measurement. However, if air sampling of a cubic meter of air could take place over three minutes, then a measurement per lot may be possible and contribute to an increase in the yield of the product.

Thus, there is a need for an airborne particle concentration and collection.

### SUMMARY OF THE INVENTION

Embodiments of an apparatus for concentrating and collecting airborne particles (e.g., biological aerosols) from an air sample include an inlet adapted for receiving the air sample (e.g., from an external or surrounding environment), a first diffuser coupled to the inlet and adapted to concentrate the airborne particles into a particle flow, and at least a second diffuser coupled to the first diffuser in a cascaded configuration and adapted to further concentrate the particle flow.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view of one embodiment of an apparatus 100 for collecting and concentrating airborne particles, according to the present invention.

To facilitate understanding, identical reference numerals have been used, where possible, to designate identical elements that are common to the figures.

### DETAILED DESCRIPTION

Embodiments of the invention generally provide a compact, lightweight, low power and low noise device capable of collecting respirable airborne particles and focusing them into a smaller, more concentrated volume. In one embodiment, the device comprises a plurality of cascaded conical diffusers that employ a careful balance of aerodynamic and electrostatic forces to collect and slow airborne particles into a radially concentrated air stream with entrained particles. Embodiments of the present invention are capable of achieving a particle concentration of approximately 300 times or more, depending on efficiency at particle size.

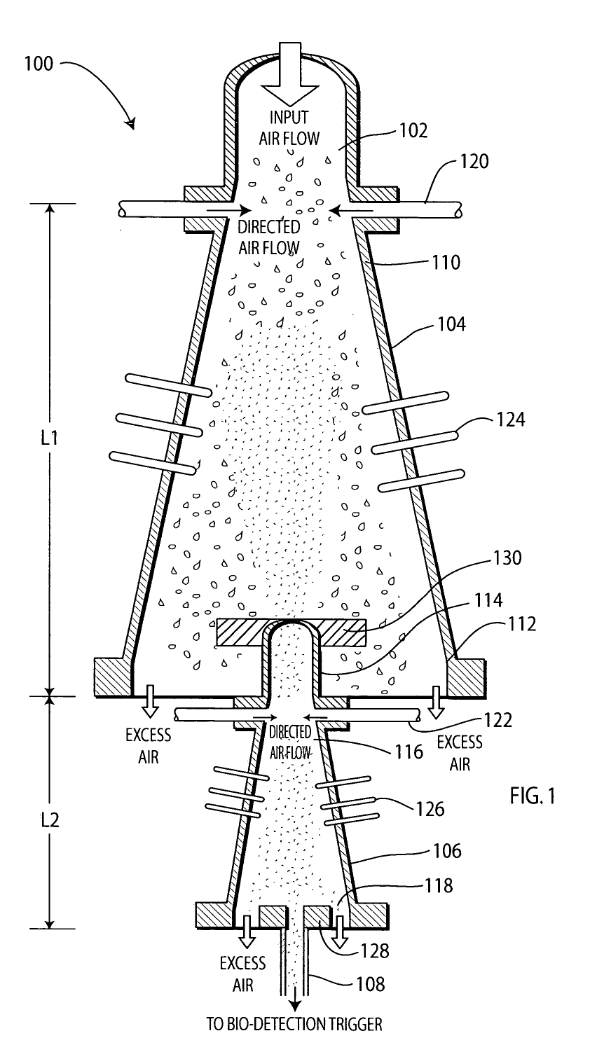

FIG. 1 is a cross-sectional view of one embodiment of an apparatus 100 for collecting and concentrating airborne particles, according to the present invention. The apparatus 100 may be incorporated in a particle collection system such as that described in U.S. patent application Ser. No. 10/603,119 (entitled “Method And Apparatus For Concentrated Airborne Particle Collection”), which is herein incorporated by reference in its entirety. In the illustrated embodiment, the apparatus 100 comprises an inlet 102, a first diffuser 104, at least a second diffuser 106 and an outlet 108.

The inlet 102 is adapted to receive an input gas or air stream containing airborne particles (e.g., from the surrounding environment) and provide the input air stream to the first diffuser 104 for initial concentration. In one embodiment, the inlet 102 is adapted to receive air flows at a volumetric rate of up to 300 L/min.

The first diffuser 104 is a high-volume diffuser (e.g., where “high” is a relative term in relation to the second diffuser 106). The first diffuser 104 is adapted to receive an input air stream from the inlet 102 and uniformly reduce the air flow velocity. The reduction in airflow velocity enables forces other than those associated with the principle gas or air flow to be brought to bear. In one embodiment, the first diffuser 104 reduces the volume of the input air stream by approximately five to ten times (e.g., from 300 L/min to as little as 30 L/min).

The first diffuser 104 is substantially conical in shape, with the narrower end 110 of the cone interfaced to the inlet 102. The wider end 112 of the cone-shaped first diffuser 104 is interfaced to the second diffuser 106 via a grounded, small-diameter output tube 114 that receives the reduced-speed air stream and provides the reduced-speed air stream to the second diffuser 106. The conical shape of the first diffuser 104 aids in uniformly reducing the velocity of the input air stream and particles as they travel through the increasing cross section. The diameters of the first diffuser 104 at the narrower end 110 and the wider end 112 are chosen to ensure laminar flow and substantially prevent recirculation zones at the edges of the walls of the first diffuser 104. In one embodiment, the ratio of the diameter of the narrower end 110 to the diameter of the wider end 112 is determined by an included cone angle of less than approximately fifteen degrees.

In addition, the first diffuser 104 includes a first directed air flow inlet 120 positioned near the narrower end 110 of the cone (e.g., near the inlet 102). The first directed air flow inlet 120 is adapted to provide a high-velocity sheath of air at the wall of the first diffuser 104. This high-velocity sheath of air will aid in reducing air flow separation at the narrower end 110 of the cone, thereby helping to keep airborne particles from adhering to the walls of the first diffuser 104 and improving overall particle efficiency of the apparatus 100. In one embodiment, several directed air flow inlets may be positioned near the narrower end 110 of the cone in order to provide several high-velocity directed air flows.

In further embodiments still, the first diffuser 104 further comprises a first AC corona discharge component 130 positioned near the wider end 112 of the cone (e.g., around the output tube 114). The first AC corona discharge component 130 helps to improve concentration efficiency in the output air stream, as discussed in further detail below.

The second diffuser 106 is a low-volume diffuser (e.g., where “low” is a relative term in relation to the first diffuser 104). The second diffuser 106 is adapted to receive the reduced-speed air stream from the first diffuser 104 (e.g., via the output tube 114) and slow down the air flow down even further. In one embodiment, the second diffuser 106 reduces the volume of the input air stream by approximately another sixty times (e.g., from 30 L/min to 0.5 L/min). Thus, the first diffuser 104 and the second diffuser 106 in combination are capable of reducing the input air volume by approximately six hundred times its original volume. In one embodiment, the length, L₂ of the second diffuser, is smaller than the length, L₁ of the first diffuser.

Like the first diffuser 104, the second diffuser 106 is substantially conical in shape, with the narrower end 116 of the cone interfaced to the first diffuser 104 (e.g., via the output tube 114). The wider end 118 of the cone-shaped second diffuser 106 is interfaced to the outlet 108. The conical shape of the first diffuser 106 aids in uniformly reducing the velocity of the input air stream and particles as they travel through the increasing cross section. The diameters of the second diffuser 106 at the narrower end 116 and the wider end 118 are chosen to ensure laminar flow and substantially prevent recirculation zones at the edges of the walls of the second diffuser 106. In one embodiment, the ratio of the diameter of the narrower end 116 to the diameter of the wider end 118 is determined by an included cone angle of less than approximately fifteen degrees.

In addition, the second diffuser 106 includes a second directed air flow inlet 122 positioned near the narrower end 116 of the cone (e.g., near the output tube 114). The second directed air flow inlet 122 is adapted to provide a high-velocity sheath of air at the wall of the second diffuser 106. This high-velocity sheath of air will aid in reducing air flow separation at the narrower end 116 of the cone, thereby helping to keep airborne particles from adhering to the walls of the second diffuser 106 and improving overall particle efficiency of the apparatus 100. In one embodiment, several directed air flow inlets may be positioned near the narrower end 116 of the cone in order to provide several high-velocity directed air flows.

The outlet 108 is adapted to receive the reduced volume (and thus reduced-speed) air stream from the second diffuser 106 and to provide the reduced-speed air stream to any one of a number of bio-detection triggers (not shown, e.g., including bio-detector triggers requiring single-particle interrogation) or to other target surfaces or devices for subsequent analysis. In one embodiment, the outlet 108 is adapted to interface directly to a bio-detection trigger. In further embodiments, the geometry of the outlet 108 is designed to generate higher aerodynamic velocity within the outlet 108 (as compared to within the second diffuser 106). In one embodiment, higher aerodynamic velocity within the outlet 108 is generated by reducing the diameter of the end of the outlet 108 (e.g., near the portion that interfaces with a bio-detection trigger). In one embodiment, the outlet 108 has a diameter of approximately 1.5 mm. In further embodiments, the outlet 108 is grounded. In further embodiments still, the outlet 108 further comprises a second AC corona discharge component 128 positioned near the entrance of the outlet 108 (e.g., within the second diffuser 106). The second AC corona discharge component 128 helps to improve concentration efficiency in the output air stream, as discussed in further detail below.

In further embodiments, the apparatus 100 further comprises an electrostatic focusing system for creating a radially concentrated particle stream within the main stream of the input air flow. In one embodiment, the electrostatic focusing system comprises a first radial array 124 of corona electrodes, a second radial array 126 of corona electrodes, the grounded output tube 114 and the grounded outlet 108. The first radial array 124 is positioned around the wall (e.g., around at least a portion of the circumference) of the first diffuser 104 (e.g., between the narrower end 110 and the wider end 112). The second radial array 126 is positioned around the wall (e.g., around at least a portion of the circumference) of the second diffuser 106 (e.g., between the narrower end 116 and the wider end 118). In further embodiments, the first and second radial arrays 124 and 126 of corona electrodes may be positioned closer to the entrances of the first and second diffusers 104 and 106, respectively.

Although the apparatus 100 is illustrated as comprising two diffusers (i.e., first diffuser 104 and second diffuser 106), it will be appreciated that embodiments of the apparatus 100 may comprise more than two diffusers configured similarly to the first diffuser 104 and the second diffuser 106 and collectively arranged in a cascaded orientation to increase the input volume flow rate of the apparatus 100.

In operation, the apparatus 100 receives an input air stream, containing airborne particles (e.g., aerosol particles), through the inlet 102. In one embodiment, the input air stream is drawn in at least in part by a fan in the first diffuser 104 (e.g., positioned near the wider end 112, but not shown). As the input air stream travels from the inlet 102 into the first diffuser 104, the directed air flow provided by the first directed air flow inlet 120 provides a sheath of air to keep particles off the walls of the first diffuser 104, thereby reducing the number of particles that adhere to the diffuser walls. The velocity of the input air stream slows by up to approximately ten times as the input air stream travels from the narrower end 110 of the first diffuser 104 to the wider end 112. In addition, the incoming particles are charged to a common polarity by the first radial array 124 of corona electrodes, which creates a large ion density that attaches ions to the surfaces of the particles. In the case where the first radial array 124 of corona electrodes is positioned near the entrance of the first diffuser 104, the particles will be charged as they enter the diffuser. Moreover, an electrostatic field generated between the first array 124 of corona electrodes and the grounded output tube 114 focuses the particles into roughly the center of the air flow through the first diffuser 104, thereby providing a higher concentration of particles to the second diffuser 106.

In one embodiment, particles are extracted out of the first diffuser 104 through output tube 114 by a fan (not shown) positioned near the wider end 118 of the second diffuser 106. The excess air in the first diffuser 104 exits through the wider end 112 of the first diffuser 104 via a fan (not shown) positioned near the wider end 112, leaving a more concentrated particle-to-air volume ratio than the originally input particle-to-air volume ratio. The first AC corona discharge component 130 helps to discharge extracted particles upon exit from the first diffuser 104, preventing the particles from adhering to the grounded output tube 114.

At the output tube 114, the first AC corona discharge component 130 produces ions of both positive and negative polarity. The alternating electric field and ion current neutralizes particles entering the output tube 114, thereby substantially reducing the number of particles that adhere to the walls of the output tube 114. Particle extraction from the output tube 114 is also enhanced by the geometry of the output tube 114 itself, which generates higher aerodynamic velocity within the output tube 114. The localized particle discharge achieved by the first AC corona discharge component 130, combined with the aerodynamic extraction achieved by the geometry of the output tube 114 further improves the efficiency of the apparatus 100 by providing improved particle concentration in particles in the output air stream. Excess air (e.g., substantially depleted of airborne particles) is discharged though the wider end 112 of the first diffuser 104 (e.g., around the output tube 114).

Air flow through the second diffuser 106 is affected by much the same forces. The slowed down, radially concentrated air flow from the first diffuser 104 is received by the second diffuser 106 via the output tube 114. This radially concentrated flow is additionally slowed as is travels from the narrower end 116 of the second diffuser 106 to the wider end 118, where the electrostatic forces now dominate the aerodynamic forces, thereby allowing the particles to be concentrated into the center of the second diffuser 106. Directed air flow provided by the second directed air flow inlet 122 reduces the number of particles that adhere to the diffuser walls. The second radial array 126 of corona electrodes recharges the discharged particles from the previous stage, and, via electrostatic fields created between the second radial array 126 of corona electrodes and the grounded outlet 108, pushes the charged particles to the center of the second diffuser 106, further concentrating the particles. The further concentrated particles are then extracted (e.g., by suction created through the outlet 108 by a fan or pump, not shown) via the grounded outlet 108, in a manner similar to the extraction from the grounded output tube 114 described above. The excess, substantially particle-free air exits the second diffuser 106 through the wider end 118 of the second diffuser 106 (e.g., assisted by a fan). Thus, a significantly reduced volume of air having a high particle concentration (e.g., approximately 300 to 600 times the original input airflow) is ultimately provided to the outlet 108.

At the outlet 108, the particles are extracted in a manner similar to extraction through the output tube 114 (e.g., implementing the second AC corona discharge component 128 in conjunction with the geometry of the outlet 108 itself, which, as described above, generates higher aerodynamic velocity within the outlet 108). Excess air (e.g., substantially depleted of airborne particles) is discharged though the wider end 118 of the second diffuser 106 (e.g., around the outlet 108).

In an alternative embodiment, where the output concentrated particle flow is to be deposited onto a target or test surface, a high voltage (e.g., approximately −10 Kv) is applied to the outlet 108 to produce a corona discharge at the tip of the outlet 108. The exiting particles are then charged and can be selectively deposited onto a grounded substrate.

The design of the apparatus 100 thereby provides improved particle concentration in a sampled air flow by using a multi-stage cascaded diffuser design enhanced with electrostatic and aerodynamic manipulation of incoming particles. Moreover, the design is easily scalable to higher flow rates, maintaining concentration and efficiency at low power by adding extra cascaded diffusers. In one embodiment, scalability is enhanced relative to the first diffuser 104 by adding more corona electrodes to the first radial array 124 of corona electrodes, by increasing the electric potential of the corona electrodes in the first radial array 124, and by increasing the ion current between the first radial array 124 of corona electrodes and the grounded output tube 114 when enlarging the size of the first diffuser 104. Both the first diffuser 104 and the second diffuser 106 employ the same principles of aerodynamics and electrostatics to collect and slow down incoming air flows (including airborne particles) into a radially concentrated particle stream.

The second diffuser 106 consumes less power (e.g., less than approximately 10 Watts) that the first diffuser 104 (e.g., less than approximately 30 Watts) because the distance from the second radial array 126 of corona electrodes in the second diffuser 106 is a shorter distance from the grounded outlet 108 than the first radial array 124 of corona electrodes in the first diffuser 104 is from the grounded output tube 114.

Moreover, the ability to manipulate particle flow more precisely (e.g., through use of the aerodynamic and electrostatic manipulation of particles into a concentrated, low velocity airflow) may be applied to advantage in other scenarios, such as the localization of particle samples for processing (e.g., deposit onto a test or target surface) and the sorting of particles (e.g., removal from a main gas or air flow).

Thus, the present invention represents a significant advancement in the field of bio-aerosol collection. The present invention provides a simple, yet powerful approach for concentrating particulates while maintaining high collection efficiency through a balance of electrostatic and aerodynamic forces. Moreover, the present invention achieves advanced charging and focusing of airborne particles through electrostatic control and low-volume particle extraction based on discharging and aerodynamic extraction. The inherent scalability of the present invention also makes it practical for use in a wide variety of applications, including field applications in which pollutants, chemical, biological and nuclear threats must be removed or detected (e.g., from building ventilation systems, stadiums, public gathering points and other sites in which large amounts of human traffic pass).

While the foregoing is directed to embodiments of the invention, other and further embodiments of the invention may be devised without departing from the basic scope thereof, and the scope thereof is determined by the claims that follow.

What is claimed is:

1. An apparatus for collecting airborne particles from an air sample comprising:
an inlet adapted for receiving said air sample from an external environment;
a first diffuser coupled to said inlet and adapted to concentrate said airborne particles into a particle flow; and
at least a second diffuser coupled to said first diffuser in a cascaded configuration and adapted to further concentrate said particle flow.

2. The apparatus of claim 1, further comprising:
an outlet coupled to said second diffuser and adapted to receive said particle flow for discharge from said apparatus.

3. The apparatus of claim 2, wherein said outlet is directly coupled to a particle analysis device.

4. The apparatus of claim 2, wherein said outlet is configured to deposit said particle flow on a target surface.

5. The apparatus of claim 2, wherein said outlet further comprises:
an AC corona discharge component positioned near an entrance of said outlet.

6. The apparatus of claim 1, wherein at least one of said first diffuser and said second diffuser is conical in shape.

7. The apparatus of claim 1, wherein at least one of said first diffuser and said second diffuser further comprises:
at least one directed air flow inlet for providing a high-velocity sheath of air through said at least one of said first diffuser and said second diffuser.

8. The apparatus of claim 1, wherein at least one of said first diffuser and said second diffuser further comprises:
a radial array of corona electrodes positioned around at least a portion of a circumference of said at least one of said first diffuser and said second diffuser.

9. The apparatus of claim 1, further comprising:
a means for excess air to be discharged from said second diffuser.

10. The apparatus of claim 1, wherein a length of said second diffuser is shorter than a length of said first diffuser.

11. A method for collecting airborne particles from an air sample, said method comprising:
passing said air sample through a first diffuser to concentrate said airborne particles into a particle flow; and
passing said particle flow through at least a second diffuser coupled to said first diffuser in a cascaded configuration.

12. The method of claim 11, wherein said passing through said first diffuser and said second diffuser slows a velocity of said particle flow.

13. The method of claim 12, wherein said passing through said second diffuser slows said velocity to a greater extent than said passing through said first diffuser.

14. The method of claim 11, further comprising:
providing a directed air flow through at least one of said first diffuser and said second diffuser.

15. The method of claim 14, wherein said directed air flow reduces an amount of said particles that adhere to walls of said at least one of said first diffuser and said second diffuser.

16. The method of claim 11, further comprising:
electrostatically charging said particles as said particles pass through at least one of said first diffuser and said second diffuser.

17. The method of claim 16, wherein said charging is accomplished by an array of corona electrodes positioned around at least a portion of a circumference of said at least one of said first diffuser and said second diffuser.

18. The method of claim 11, further comprising:
electrostatically focusing said particle flow for passage through an outlet of at least one of said first diffuser and said second diffuser.

19. The method of claim 18, wherein said focusing comprises:
positioning an array of corona electrodes positioned around at least a portion of a circumference of said at least one of said first diffuser and said second diffuser;
positioning a grounded outlet proximate to said outlet of at least one of said first diffuser and said second diffuser; and
creating an electrostatic field between said array and said grounded outlet.

20. The method of claim 11, further comprising:
providing said particle flow to at least one of: a particle analysis device and a target surface.

21. The method of claim 11, further comprising:
neutralizing said particles to facilitate extraction to an outlet.

22. The method of claim 21, further comprising:
aerodynamically manipulating said neutralized particles to further facilitate extraction.
